(19) United States
(12) Patent Application Publication
(10) Pub. No.: US 2026/0051763 A1
(43) Pub. Date: Feb. 19, 2026

(54) BACKUP POWER SUPPLY SYSTEM CONTROL METHOD AND BACKUP POWER SUPPLY SYSTEM

(71) Applicant: Panasonic Intellectual Property Management Co., Ltd., Osaka (JP)

(72) Inventors: YO KUMODA, Osaka (JP); HIROKI AKASHI, Osaka (JP); YUTA NAGATOMI, Osaka (JP); TAKASHI KAWAI, Fukui (JP); MASAKI NAKAMURA, Fukui (JP)

(21) Appl. No.: 19/106,653

(22) PCT Filed: Aug. 9, 2023
(86) PCT No.: PCT/JP2023/029035

§ 371 Date: Feb. 26, 2025

(30) Foreign Application Priority Data
Oct. 24, 2022 (JP) 2022-170099

(51) Int. Cl. H02J 9/06; H02M 3/155

(52) U.S. Cl. CPC H02J 9/061; H02M 3/155

(57) ABSTRACT

In a backup power supply system, an input port is configured to be connected to a power supply, and an output port is configured to be connected to a load. A power supply path connects the input port to the output port. A first voltage converter is connected between the power supply path and a power storage unit. A second voltage converter has a first end connected to the power supply path and a second end connected to the output port. A reverse flow prevention unit is connected between the input port and the output port to prevent a current flow from the second end of the second voltage converter to the input port. A first capacitor has a first end and a second end which is connected to ground. The first end of the first capacitor is connected between the input port and a node connected to the first and second voltage converters.

### TECHNICAL FIELD

The present disclosure relates to a method of controlling a backup power supply system and to a backup power supply system. More particularly, the present disclosure relates to a method of controlling a backup power supply system and to a backup power supply system for supplying power to a load at a failure of a power supply.

### BACKGROUND ART

PTL 1 discloses a backup circuit for supplying power from a power storage unit to a power supply target when a power supply from a power supply unit stops.

When the power supply from the power supply unit is normal, the backup circuit supplies power to a first power supply target from the power supply unit via a power supply-side conductive path and a first load-side conductive path, and supplies power to a second power supply target from the power supply unit via the power supply-side conductive path and a second load-side conductive path.

The backup circuit includes the power storage unit, a first voltage converter, a second voltage converter, and an element unit.

The first voltage converter performs a first operation of boosting or stepping down an input voltage from the power supply unit to charge the power storage unit, and a second operation of boosting or stepping down a voltage of the power storage unit to output the voltage to the power supply-side conductive path at a failure of the power supply unit.

The second voltage converter boosts up or steps down the voltage of the power storage unit to output the voltage to an intermediate conductive path.

The element unit is connected between the intermediate conductive path and the second load-side conductive path. The element unit allows a current flow from the intermediate conductive path to the second load-side conductive path when the element unit is in a first state that a potential of the intermediate conductive path is higher than a potential of the second load-side conductive path for a predetermined potential difference or more. The element unit restricts the current flow from the intermediate conductive path to the second load-side conductive path when the element unit is in a second state that the first state is released.

As a result, at the failure of the power supply unit, the second voltage converter supplies power to the second load-side conductive path via the intermediate conductive path and the second load-side conductive path until the first voltage converter starts to supply power to the power supply-side conductive path. Accordingly, power is immediately started to supply to the second power supply target.

### CITATION LIST

### Patent Literature

PTL 1: Japanese Patent Laid-Open Publication No. 2019-193493.

### SUMMARY OF INVENTION

In the backup circuit described above, the second voltage converter that supplies power to the second power supply target boosts or steps down the voltage of the power storage unit and outputs it to the intermediate power supply unit until the first voltage converter starts supplying power to the power supply-side conductive path at a failure of the power supply unit. Therefore, the second voltage converter requires a voltage conversion circuit capable of both the boosting operation and the step-down operation. This configuration causes the second voltage converter to have a complicated circuit configuration, accordingly requiring a large mounting area of the second voltage converter and increasing the size of the entire backup circuit.

A method of controlling a backup power supply system according to an aspect of the present disclosure is a method of controlling a backup power supply system connected between a power supply and a load. The backup power supply system includes an input port, an output port, a power supply path, a power storage unit, a first voltage converter, a second voltage converter, a reverse flow prevention unit, a controller, a first capacitor, a second capacitor, and a third capacitor. The input port is connected to the power supply. The output port is connected to the load. The power supply path connects the input port to the output port. The first voltage converter is connected between the power supply path and the power storage unit. The second voltage converter has a first end and a second end, the first end of the second voltage converter being connected to the power supply path, the second end of the second voltage converter being connected to the output port. The reverse flow prevention unit is connected between the input port and the output port and configured to prevent a current flow from the second end of the second voltage converter to the input port. The controller is configured to control the first voltage converter and the second voltage converter. The first capacitor has a first end and a second end, the first end of the first capacitor being connected to the first voltage converter and the second voltage converter and the input port, the second end of the first capacitor being connected to ground. The second capacitor has a first end and a second end, the first end of the second capacitor being connected between the first voltage converter and the power storage unit, the second end of the second capacitor being connected to ground. The third capacitor has a first end and a second end, the first end of the third capacitor being connected between the second voltage converter and the output port, the second end of the third capacitor being connected to ground. The controller performs a charging step in which the first voltage converter is controlled to convert an input voltage from the power supply and output the converted input voltage to the power storage unit when the power supply operates normally. The controller performs a first power supply step in which the second voltage converter is controlled to boost a voltage of electrical energy stored in the first capacitor and output the boosted voltage of the stored electrical energy to the output port for a first period in which a voltage of the power supply path is lower than an output voltage of the second voltage converter before and after a failure of the power supply. The controller performs a second power supply step in which the first voltage converter is controlled to convert a voltage of electrical energy discharged from the power supply unit and output the converted voltage of the discharged electrical energy to the output port via the power supply path for a second period in which the voltage of the power supply path is higher than or equal to the output voltage of the second voltage converter after the failure of the power supply.

A backup power supply system according to an aspect of the present disclosure is a backup power supply system configured to be connected between a power supply and a load. The backup power supply system includes an input port, a first output port, a power supply path, a power storage unit, a first voltage converter, a second voltage converter, a reverse flow prevention unit, a controller, a first capacitor, a second capacitor, and a third capacitor. The input port is configured to be connected to the power supply. The first output port is configured to be connected to the load. The power supply path connects the input port to the first output port. The first voltage converter is connected between the power supply path and the power storage unit. The second voltage converter has a first end and a second end, the first end of the second voltage converter being connected to the power supply path, the second end of the second voltage converter being connected to the first output port. The reverse flow prevention unit is connected between the input port and the first output port, the reverse flow prevention unit being configured to prevent a current flow from the second of the second voltage converter to the input port. The controller is configured to control the first voltage converter and the second voltage converter. The first capacitor has a first end and a second end, the first end of the first capacitor being connected between the first voltage converter and the second voltage converter, the second end of the first capacitor being connected to ground. The second capacitor has a first end and a second end, the first end of the second capacitor being connected between the first voltage converter and the power storage unit, the second end of the second capacitor being connected to ground. The third capacitor has a first end and a second end, the first end of the third capacitor being connected between the second voltage converter and the first output port, the second end of the third capacitor being connected to ground.

The backup power supply system according to the present disclosure has a small size.

### BRIEF DESCRIPTION OF DRAWINGS

FIG. 1 is a schematic circuit diagram of a backup power supply system according to an exemplary embodiment of the present disclosure.

FIG. 2 is a schematic circuit diagram of the backup power supply system according to the embodiment.

FIG. 3 is a schematic circuit diagram of the backup power supply system according to the embodiment.

FIG. 4 is a schematic circuit diagram of a first voltage converter of the backup power supply system according to the embodiment.

FIG. 5 is a waveform chart of voltages at parts of the backup power supply system according to the embodiment.

FIG. 6 is a schematic circuit diagram of a backup power supply system according to Modification 1.

FIG. 7 is a schematic circuit diagram of a backup power supply system according to Modification 2.

FIG. 8 is a schematic circuit diagram of a backup power supply system according to Modification 3.

FIG. 9 is a schematic circuit diagram of a backup power supply system according to Modification 4.

FIG. 10 is a waveform chart of voltages at parts of the backup power supply system according to Modification 4.

### DESCRIPTION OF EMBODIMENT

An exemplary embodiment of a backup power supply system and a backup power supply system control method will be described below. The embodiment disclosed below is merely an example. The present disclosure is not limited to the embodiment described below, and various modifications according to design may be made without departing from the effects of the present disclosure.

### (1) Outline

Backup power supply system 1 according to an exemplary embodiment is configured to be connected between power supply 2 and load 3.

Backup power supply system 1 includes input port T1, output port T2 power supply path P1, power storage unit 13, first voltage converter 11, second voltage converter 12, reverse flow prevention unit 16, controller 14, first capacitor C1, second capacitor C2, and third capacitor C3.

Input port T1 is configured to be connected to power supply 2.

Output port T2 is configured to be connected to load 3.

Power supply path P1 connects input port T1 to output port T2.

First voltage converter 11 is connected between power supply path P1 and power storage unit 13.

Second voltage converter 12 has a first end and a second end. The first end of the second voltage converter 12 is connected to power supply path P1. The second end of the second voltage converter 12 is connected to output port T2.

Reverse flow prevention unit 16 is connected between input port T1 and output port T2. Reverse flow prevention unit 16 is configured to prevent a current flow from the second end of second voltage converter 12 to input port T1, and not to prevent a current flow from input port T1 to the second end of second voltage converter 12.

Controller 14 is configured to control first voltage converter 11 and second voltage converter 12.

First capacitor C1 has a first end and a second end. The first end of the first capacitor C1 is connected between input port T1 and each of first voltage converter 11 and second voltage converter 12. The second end of the first capacitor C1 is connected to ground.

Second capacitor C2 has a first end and a second end. The first end of the second capacitor C2 is connected between first voltage converter 11 and power storage unit 13. The second end of the second capacitor C2 is connected to ground.

Third capacitor C3 has a first end and a second end. The first end of the third capacitor C3 is connected between second voltage converter 12 and output port T2. The second end of the third capacitor C3 is connected to ground.

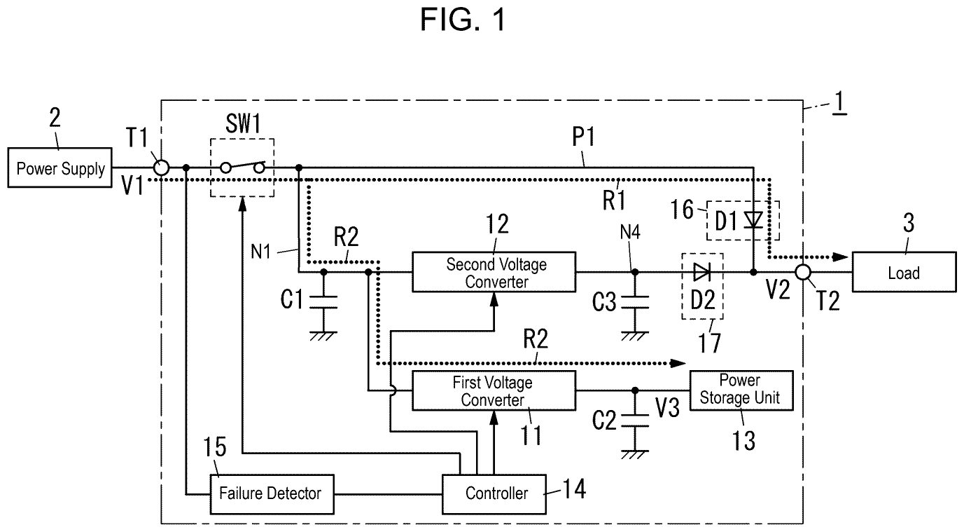

In this configuration, power supply path P1 includes a conductive path between input port T1 and output port T2, and further includes a conductive path between input port T1 and first voltage converter 11, and a conductive path between input port T1 and second voltage converter 12. In the description, when two circuit elements are “connected”, it means that two circuit elements are electrically connected. However, “connected” is not necessarily a direct connection of two circuit elements and includes an indirect connection of two circuit elements via another circuit element. The “ground” is a reference potential of first voltage converter 11 and second voltage converter 12. Although illustration is omitted in FIG. 1 and other drawings, power supply 2 and load 3 are also connected to the reference potential (ground) of first voltage converter 11 and second voltage converter 12. In other words, power supply 2 is connected between input port T1 and the reference potential (ground) of first voltage converter 11 and second voltage converter 12. Still more, load 3 is connected between output port T2 and the reference potential (ground) of first voltage converter 11 and second voltage converter 12.

When power supply 2 fails, controller 14 controls first voltage converter 11 to convert a voltage of power storage unit 13 and output the converted voltage to power supply path P1. Here, a failure state that power supply 2 fails is a state that power supplied from power supply 2 to load 3 is stopped due to a breakdown or deterioration of power supply 2 or disconnection in a circuit of power supply 2. When input voltage VI input from power supply 2 to input port T2 falls below a failure threshold, controller 14 determines that power supply 2 is in the failure state. Note that, depending on a type of abnormality that occurs in power supply 2 or the circuit of power supply 2, input voltage V1 may immediately fall below the failure threshold or gradually decrease and fall below the failure threshold. A non-failure state that power supply 2 does not fail is a state that input voltage V1 from power supply 2 is higher than the failure threshold, and load 3 operates with power supplied from power supply 2.

Second voltage converter 12 converts a voltage across both ends of first capacitor C1 and outputs the converted voltage to load 3. Second voltage converter 12 continuously performs the voltage conversion operation such that second voltage converter 12 is configured to supply power to load 3 via output port T2 in a first period before and after the failure of power supply 2 in which a voltage of power supply path P1 falls below an output voltage of second voltage converter 12. This configuration reduces the possibility of a temporal stop of power supply to load 3 when power supply 2 fails. For example, the output voltage of second voltage converter 12 is preferably set to a voltage higher than a lower limit threshold voltage that can power the load, and set to a voltage lower than a voltage of power supply path P1 in the normal state (i.e., voltage value of a voltage input from power supply 2 operating in the normal state). The normal state is a state that power supply 2 has no abnormalities including short-circuiting and disconnection in a circuit between power supply 2 and input port T1.

Since the voltage of first capacitor C1 does not exceed input voltage VI from power supply 2, second voltage converter 12 does not need to perform a step-down operation. Second voltage converter 12 only perform a boosting operation to boost the voltage of first capacitor C1 and outputting the boosted voltage to output port T2. Second voltage converter 12 may therefore be implemented by a circuit for the boosting operation, thus having a simple circuit configuration compared with second voltage converter 12 implemented by a circuit configured to performing both the boosting operation and the step-down operation. This configuration reduces the size of backup power supply system 1.

### (2) Details

Backup power supply system 1 according to the embodiment will be detailed below with reference to the drawings.

Backup power supply system 1 is installed to a movable object, such as a vehicle. In other words, the movable object includes backup power supply system 1 and a movable body (e.g., vehicle body). The movable body has backup power supply system 1, power supply 2, and load 3 installed thereto. When power supply 2, such as a battery, of the vehicle fails, backup power supply system 1 supplies power from power storage unit 13 to load 3. Load 3 is an electric actuator, such as a power brake system or a controller that controls the electric actuator. As a result, even when power supply 2 fails, load 3 continuously operate with power supplied from backup power supply system 1.

Backup power supply system 1 installed to the vehicle will be exemplified below. The movable object may not necessarily be the vehicle, and may be, e.g., an aircraft, ship, or train. Backup power supply system 1 is not necessarily installed to the movable object, and may be installed to a facility for use.

### (2.1) Configuration

As described above, backup power supply system 1 includes input port T1, output port T2, power supply path P1, power storage unit 13, first voltage converter 11, second voltage converter 12, reverse flow prevention unit 16, controller 14, first capacitor C1, second capacitor C2, and third capacitor C3 (see FIGS. 1-3). Reverse flow prevention unit 16 may be indicated as first reverse flow prevention unit 16. Backup power supply system 1 further includes switch SW1, failure detector 15, and second reverse flow prevention unit 17.

Input port T1 is configured to be connected to power supply 2, such as a battery installed to the vehicle. Although illustration is omitted in FIG. 1 and other drawings, a terminal on a low-potential (negative electrode) of power supply 2 is connected to ground of backup power supply system 1. In other words, a terminal on a high-potential (positive electrode) of power supply 2 is connected to input port T1, and a terminal on the low-potential (negative electrode) of power supply 2 is connected to ground.

Load 3 is connected to output port T2. Although illustration is omitted in FIG. 1 and other drawings, a terminal of load 3 on the low-potential side is connected to ground of backup power supply system 1. More specifically, a terminal of load 3 on the high-potential side is connected to output port T2, and the terminal of load 3 on the low-potential side is connected to ground of backup power supply system 1. In general, a lower limit threshold voltage is set to a voltage powering an electrical apparatus. When a supply voltage applied to the electrical apparatus continuously fall below the lower limit threshold voltage, the electrical apparatus is inoperative. The electrical apparatus includes a first load that does not allow a state that the voltage supplied to the first load falls below the lower limit threshold voltage, i.e., the supply voltage more than or equal to the lower limit threshold voltage must always be supplied, and a second load that allows a state that the voltage supplied to the second load temporarily falls below the lower limit threshold voltage. The second load is, for example, an electric actuator, such as a power brake system. The first load is, for example, a controller, such as an electronic control unit (ECU) that controls the electric actuator. In accordance with the embodiment, load 3 connected to backup power supply system 1 is the first load that does not allow the state that the voltage supplied to the load falls below the lower limit threshold voltage.

Input port T1 is connected to output port T2 via power supply path P1.

Input port T1 is connected to a first end of first capacitor C1 via switch SW1, and a second end of first capacitor C1 is connected to ground. In other words, first capacitor C1 is connected between input port T1 and the ground via switch SW1.

Switch SW1 is, for example, a semiconductor switch, such as a metal-oxide semiconductor field-effect transistor (MOSFET). Switch SW1 is connected between input port T1 and first capacitor C1 and between input port T1 and reverse flow prevention unit (first reverse flow prevention unit) 16. Controller 14 controls turning on and off of switch SW1. Controller 14 turns on switch SW1 in a non-failure state of power supply 2. Controller 14 turns off switch SW1 when power supply 2 fails (failure state).

First voltage converter 11 is connected between power supply path P1 and power storage unit 13. First voltage converter 11 is, for example, a bidirectional DC-DC converter configured to perform both the boost operation and the step-down operation. In accordance with the embodiment, a first end of first voltage converter 11 is connected to node N1 connected to switch SW1 and first capacitor C1. A second end of first voltage converter 11 is connected to a terminal of power storage unit 13 on the high-potential side (positive electrode side). First capacitor C1 is connected between the first end of first voltage converter 11 and the ground. Second capacitor C2 is connected between the second end of first voltage converter 11 and the ground.

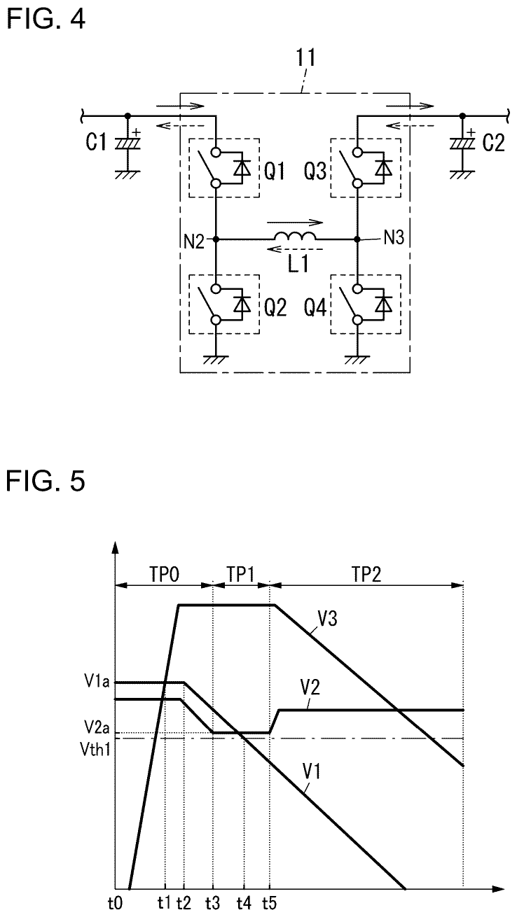

FIG. 4 is a circuit diagram of an example of first voltage converter 11. First voltage converter 11 includes four switching elements Q1-Q4 and inductor L1. A series circuit of switching elements Q1 and Q2 connected in series to each other is connected in parallel to first capacitor C1. A series circuit of switching elements Q3 and Q4 connected in series to each other is connected in parallel to second capacitor C2. Inductor L1 is connected between node N2 connected to switching elements Q1 and Q2 and node N3 connected to switching elements Q3 and Q4. Switching elements Q1-Q4 are semiconductor switching elements, such as MOSFETs. Controller 14 controls turning on and off of switching elements Q1-Q4. In the non-failure state of power supply 2, first voltage converter 11 boosts or steps down the input voltage from power supply 2 to perform the charging operation of charging power storage unit 13. In the charging operation, first voltage converter 11 causes a voltage across both ends of second capacitor C2 connected to the output side to be a predetermined voltage value. In the failure state of power supply 2, first voltage converter 11 performs the discharging operation of boosting or stepping down a voltage of power storage unit 13 and output it to power supply path P1. In the discharging operation, first voltage converter 11 operates to cause a voltage across both ends of first capacitor C1 connected to the output side to become a predetermined voltage value. The output voltage for the discharging operation by first voltage converter 11 is higher than the output voltage of second voltage converter 12.

A terminal (positive electrode) of power storage unit 13 on the high-potential side is connected to a second end of first voltage converter 11, and a terminal (negative electrode) of power storage unit 13 on the low-potential side is connected to ground. Power storage unit 13 is, for example, an electrical double layer capacitor (EDLC) capable of rapid charge and discharge. Power storage unit 13 may include plural power storage modules each including the EDLC. For example, power storage unit 13 may include two or more power storage modules electrically connected in parallel or series to one another. Power storage unit 13 may include a parallel or series connection of two or more power storage modules, or their combination.

Second voltage converter 12 has the first end connected to power supply path P1 and the second end connected to output port T2. Second voltage converter 12 is, for example, a unidirectional DC-DC converter capable of the boost operation. In accordance with the embodiment, the first end of second voltage converter 12 is connected to node N1 between switch SW1 and first capacitor C1. Second reverse flow prevention unit 17 is connected between the second end of second voltage converter 12 and output port T2. First capacitor C1 is connected between the first end of second voltage converter 12 and ground. Third capacitor C3 is connected between the second end of second voltage converter 12 and ground. Controller 14 controls second voltage converter 12 to continuously perform the boost operation of boosting the input voltage (i.e., a voltage across both ends of first capacitor C1) and outputting the boosted voltage from the second end. Controller 14 controls second voltage converter 12 to cause the output voltage of second voltage converter 12 to become higher than the lower limit threshold voltage that can power load 3 and also higher than a failure threshold, but lower than the voltage of power supply path P1 in the normal state (specifically, a voltage of an anode of diode D1). At this moment, it is assumed that forward voltages of diodes D1 and D2 are the same voltage. The failure threshold is preferably set to a voltage value higher than or equal to the lower limit threshold voltage, and the failure threshold is more preferably set to a voltage value higher than the lower limit threshold voltage.

First reverse flow prevention unit 16 configured to prevent a current flow from the second end of second voltage converter 12 to input port T1, but does not prevent a current flow from input port T1 to the second end of second voltage converter 12. First reverse flow prevention unit 16 includes diode D1, such as a Schottky barrier diode. An anode of diode D1 is connected to node N1 connected to switch S1 and first capacitor C1, and a cathode of diode D1 is connected to output port T2.

Second reverse flow prevention unit 17 is connected between third capacitor C3 and output port T2 and is configured to prevent a current flow in a direction from output port T2 toward third capacitor C3, but does not prevent a current flow from third capacitor C3 to output port T2. Second reverse flow prevention unit 17 includes diode D2, such as a Schottky barrier diode. An anode of diode D2 is connected to node N4 connected to the second end of second voltage converter 12 and third capacitor C3. A cathode of diode D2 is connected to output port T2. As a result, assuming that forward voltages of diodes D1 and D2 are the same voltage, the voltage of power supply path P1 (voltage input from power supply 2 or first voltage converter 11 to anode of diode D1) or the output voltage of second voltage converter 12, whichever is higher, is output to output port T2.

When second reverse flow prevention unit 17 is not provided, in the non-failure state, second voltage converter 12 may operate to suppress the output voltage due to the voltage of power supply path P1 applied to the second end of second voltage converter 12. When the voltage of power supply path P1 decreases in this state, due to abnormality of power supply 2 or the like, a rise of the output voltage of second voltage converter 12 may delay. Therefore, in accordance with the embodiment, second reverse flow prevention unit 17 is connected between third capacitor C3 and output port T2 in order to reduce the possibility that second voltage converter 12 operates to suppress the output voltage in the non-failure state. As a result, when the voltage of power supply path P1 decreases due to, e.g., an abnormality of power supply 2, power can be promptly supplied from second voltage converter 12 to load 3.

Failure detector 15 compares input voltage V1 input from power supply 2 to input port T1 with a predetermined failure threshold. When input voltage V1 is lower than the failure threshold, controller 14 outputs a detection signal indicating the failure state. When input voltage V1 is higher than or equal to the failure threshold, failure detector 15 outputs a detection signal indicating the non-failure state to controller 14.

Controller 14 controls operations of first voltage converter 11 and second voltage converter 12 to control turning on and off of switch SW1. Controller 14 is implemented mainly by a computer system including one or more processors and a memory. A program stored in the memory of the computer system is executed by a processor of the computer system to realize functions of controller 14. The program may be stored in the memory, may be provided through an electric communication line, such as the Internet, or may be stored in and provided by a non-transitory storage medium, such as a memory card.

Controller 14 turns on switch SW1 according to the detection signal input from failure detector 15 in the non-failure state that power supply 2 has not failed. Tn the non-failure state, controller 14 performs a charging step of controlling first voltage converter 11 to convert input voltage V1 from power supply 2 and charge power storage unit 13. In the charging step, first voltage converter 11 boosts input voltage V1 (e.g., DC 12 V) from power supply 2 to a predetermined first voltage value (e.g., DC 24 V) and outputs the boosted voltage to power storage unit 13, so that power storage unit 13 is charged and the voltage of power storage unit 13 reaches a predetermined voltage value.

Controller 14 causes second voltage converter 12 to continuously operate. Controller 14 controls second voltage converter 12 to boost the voltage of first capacitor C1 to a predetermined second voltage value and output the boosted voltage. Here, the second voltage value is set to a voltage value lower than input voltage V1 of power supply 2 in the normal state, but higher than the failure threshold and also higher than the lower limit threshold voltage that can drive load 3.

When controller 14 detects a failure of power supply 2 based on the detection signal input from failure detector 15, controller 14 terminates the charging step, and controls first voltage converter 11 to convert a voltage of electrical energy discharged from power storage unit 13, and output the discharged electrical energy to power supply path P1.

Since it takes a certain time until the output voltage of first voltage converter 11 rises, the output voltage of second voltage converter 12 is output to load 3 via diode D2 and output port T2 in a first period before and after the failure of power supply 2 in which the voltage of power supply path P1 is lower than the output voltage of second voltage converter 12. In other words, in the first period, controller 14 performs a first power supply step in which second voltage converter 12 is controlled to boost a voltage of electrical energy stored in first capacitor C1, and output the stored electrical energy to output port T2.

When the output voltage of first voltage converter 11 rises and the voltage of power supply path P1 becomes higher than or equal to the output voltage of second voltage converter 12 after the failure of power supply 2 (second period), the output voltage of first voltage converter 11 is output to load 3 via diode D1 and output port T2. In other words, in the second period, controller 14 executes a second power supply step in which first voltage converter 11 is controlled to convert a voltage of electrical energy discharged from power storage unit 13, and output the discharged electrical energy to output port T2 via power supply path P1.

### (2.2) Operation

An operation of backup power supply system 1 according to the embodiment will be described with reference to FIGS. 1-3 and 5.

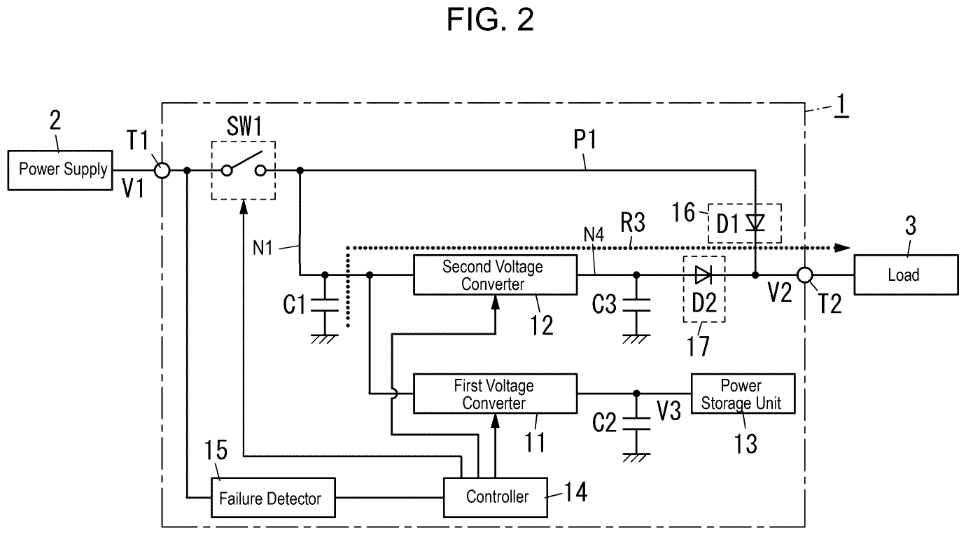

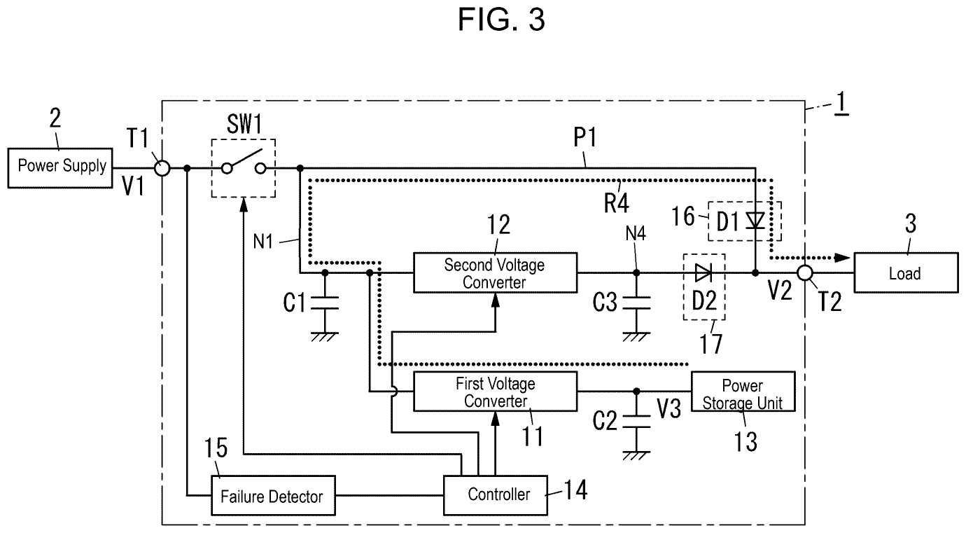

FIG. 5 is a graph illustrating temporal changes of input voltage V1 from power supply 2, voltage V2 of output port T2, and voltage V3 of power storage unit 13 before and after the failure of power supply 2. In FIG. 5, Vth1 is the failure threshold for determining whether a failure occurs in power supply 2. In FIG. 1, dotted lines R1 and R2 illustrate paths of current flowing in the charging step. In FIG. 2, dotted line R3 is a path of current flowing in the first power supply step. In FIG. 3, dotted line R4 is a path of current flowing in the second power supply step.

Power supply 2 is in the normal state from time point t0 to time point t2 in FIG. 5, and input voltage V1 from power supply 2 has normal voltage value V1a. Input voltage V1 is higher than failure threshold Vth1 in a period from time point t0 to time point t2, and thus, controller 14 performs the charging step in which first voltage converter 11 is controlled to perform the charging operation. In a period from time point t0 to time point t1, voltage V3 of power storage unit 13 is lower than input voltage V1 from power supply 2, and thus first voltage converter 11 steps down input voltage V1 and supplies a charging current to power storage unit 13 to charge power storage unit 13. After time point t1, voltage V3 of power storage unit 13 becomes higher than input voltage V1 from power supply 2, and thus first voltage converter 11 boosts input voltage V1 and supplies the charging current to power storage unit 13 to charge power storage unit 13. Power storage unit 13 is charged until, for example, the first voltage value higher than normal voltage value V1a of power supply 2. In addition, controller 14 causes second voltage converter 12 to continuously perform the voltage conversion operation, and second voltage converter 12 converts the voltage across both ends of first capacitor C1 to predetermined second voltage value V2a and outputs the converted voltage from the second end. Second voltage value V2a of second voltage converter 12 is set to a voltage higher than the lower limit threshold voltage that can power load 3 and also higher than failure threshold Vth1, but lower than the voltage of power supply path P1 in the normal state. In other words, in the period from time point t0 to time point t2, the voltage of power supply path P1 (here, voltage applied from power supply 2 to anode of diode D1) is higher than voltage value V2a of output voltage V2 of second voltage converter 12, and thus input voltage V1 from power supply 2 is supplied to load 3 via diode D1 and output port T2 to operate load 3. Dotted line R1 in FIG. 1 illustrates a current flow path from power supply 2 to load 3, and dotted line R2 illustrates a charging current flow from power supply 2 to power storage unit 13.

When any abnormality occurs in power supply 2 or a circuit between power supply 2 and input port T1 at time point t2, input voltage V1 from power supply 2 gradually decreases but input voltage V1 in a period from time point t2 to time point t4 is still higher than failure threshold Vth1, and thus failure detector 15 outputs the detection signal of the non-failure state to controller 14. Therefore, even after the occurrence of abnormality, controller 14 performs the charging step in which first voltage converter 11 is controlled to perform the charging operation in the period from time point t2 to time point t4.

In a period from time point t2 to time point t3, voltage V2 of output port T2 gradually decreases according to decreasing of input voltage V1. However, until time point t3, the voltage of power supply path P1 is higher than voltage value V2a of output voltage V2 of second voltage converter 12, and thus input voltage V1 from powers supply 2 is supplied to load 3 via diode D1 and output port T2.

On the other hand, in a period from time point t3 to time point t4, voltage value V2a of output voltage V2 of second voltage converter 12 becomes higher than the voltage of power supply path P1, and thus voltage value V2a of output voltage V2 of second voltage converter 12 is supplied to load 3 via diode D2 and output port T2. First reverse flow prevention unit 16 connected between input port T1 and output port T2 reduces the possibility of current flowing from second voltage converter 12 toward power supply 2 via power supply path P1. Dotted line R3 in FIG. 2 illustrates a current flow path from second voltage converter 12 to load 3

At time point t4, when input voltage V1 falls below failure threshold Vth1, controller 14 detects the occurrence of failure based on the detection signal from failure detector 15, and turns off switch SW1. Then, controller 14 controls first voltage converter 11 to stop the charging operation and perform the discharging operation. In other words, from time point t4, first voltage converter 11 performs the discharging operation of stepping down or boosting the voltage of power storage unit 13 and outputting it to power supply path P1. When first voltage converter 11 performs the discharging operation, a target value of the output voltage of first voltage converter 11 is set to a voltage higher than voltage value V2a of output voltage V2 of second voltage converter 12.

Here, it takes a certain time until a rise of the output voltage of first voltage converter 11, and voltage value V2a of output voltage V2 of second voltage converter 12 is higher than the voltage of power supply path P1 (here, voltage applied from first voltage converter 11 to anode of diode D1) in a period from time point t4 to time point t5. Therefore, voltage value V2a of output voltage V2 of second voltage converter 12 is supplied to load 3 via diode D2 and output port T2.

In this case, a period from time point t3 to time point t5 is before and after the failure of power supply 2, and is first period TP1 in which the voltage of power supply path P1 falls below the output voltage of second voltage converter 12. In first period TP1, controller 14 performs the first power supply step in which second voltage converter 12 is controlled to boost the voltage of electrical energy stored in first capacitor C1, and output the stored electrical energy to output port T2. In period TP0 (including a period in which power supply operates in the normal state) before first period TP1, controller 14 performs the charging step in which first voltage converter 11 is controlled to convert input voltage V1 from power supply 2 and output the converted voltage to power storage unit 13.

Then, in second period TP2 from time point t5, the output voltage of first voltage converter 11 rises, and thus the voltage of power supply path P1 (voltage applied from first voltage converter 11 to anode of diode D1) becomes higher than voltage value V2a of output voltage V2 of second voltage converter 12. When set voltage value V2b is the output voltage of first voltage converter 11 during discharge, ignoring a voltage drop in the path, set voltage value V2b of the output voltage of first voltage converter 11 during discharge is set to a voltage higher than voltage value V2a of output voltage V2 of second voltage converter 12. Therefore, in second period TP2, the output voltage of first voltage converter 11 is supplied to load 3 via diode D1 and output port T2. Accordingly, in second period TP2, controller 14 performs the second power supply step in which first voltage converter 11 is controlled to convert a voltage of electrical energy discharged from power storage unit 13, and output the discharged electrical energy to output port T2 via power supply path P1. Dotted line R4 in FIG. 3 illustrates a current flow path from first voltage converter 11 to load 3 in the second power supply step.

As described above, in backup power supply system 1 according to the embodiment, second voltage converter 12 converts the voltage of electrical energy stored in first capacitor C1 and supplies the converted voltage of the electrical energy to load 3 in first period TP1. As a result, backup power supply system 1 continuously supplies voltage higher than or equal to the lower limit threshold voltage to load 3 that does not allow a state that the voltage supplied to load 3 falls below the lower limit threshold voltage. Still more, in second period TP2 after the failure of power supply 2, first voltage converter 11 converts the voltage of electrical energy discharged from power storage unit 13 and supplies the converted voltage of the discharged electrical energy to load 3, thus continuously supplying a voltage higher than or equal to the lower limit threshold voltage to load 3.

### (3) Modifications

The above embodiment is merely an exemplary embodiment of the present disclosure. The above embodiment may be modified in various ways according to design as long as a purpose of the present disclosure is achievable. A function similar to backup power supply system 1 may be implemented by a method of controlling backup power supply system 1, a computer program, and a non-transitory storage medium storing a program therein. In a method of controlling backup power supply system according to an aspect, controller 14 performs the charging step, the first power supply step, and the second power supply step. When power supply 2 operates normally, controller 14 performs the charging step in which first voltage converter 11 is controlled to convert input voltage V1 from power supply 2 and output the converted voltage to power storage unit 13. In first period TP1 before and after the failure of power supply 2, the voltage of power supply path P1 is lower than the output voltage of second voltage converter 12, and controller 14 performs the first power supply step in which second voltage converter 12 is controlled to boost the voltage of electrical energy stored in first capacitor C1, and output the boosted voltage of the stored electrical energy to output port T2. In second period TP2 after power supply 2 fails, the voltage of power supply path P1 becomes higher than or equal to the output voltage of second voltage converter 12, and controller 14 performs the second power supply step in which first voltage converter 11 is controlled to convert the voltage of electrical energy discharged from power storage unit 13, and output the converted voltage of the discharged electrical energy to output port T2 via power supply path P1. A (computer) program according to an aspect is a program for causing a computer system (controller 14) to execute the charging step, the first power supply step, and the second power supply step.

Modifications of the above embodiment will be described below. The Modifications in the following description may be combined as required and applied.

An execution entity of backup power supply system 1 or the method of controlling backup power supply system 1 according to the present disclosure includes a computer system. The computer system mainly includes a processor and a memory as hardware. A program stored in the memory of the computer system is executed by the processor to realize backup power supply system 1 or the function as the execution subject of the method of controlling backup power supply system 1 according to the present disclosure. The program may be previously stored in the memory of the computer system, may be provided through an electric communication line, or may be stored and provided in a non-transitory storage medium, such as a memory card, an optical disk, or a hard disk drive readable with the computer system. The processor of the computer system includes one or plural electronic circuits including a semiconductor integrated circuit (IC) or large scale integrated circuit (LSI). The integrated circuit, such as IC or LSI, has a different name depending on a degree of integration, and includes a system LSI, a very large scale integration (VLSI), and an ultra large scale integration (ULSI). In addition, a field-programmable gate array (FPGA) programmed after manufacturing the LSI or a logic device whose connection relation inside LSI is reconfigurable or connection areas inside LSI are reconfigurable are also adoptable as the processor. The plural electronic circuits may be integrated in one chip or distributed in plural chips. The plural chips may be integrated in one device or may be distributed in plural devices. The computer system described herein includes a microcontroller having one or more processors and one or more memories. Thus, the microcontroller may include one or more electronic circuits including a semiconductor integrated circuit or a large scale integrated circuit.

Controller 14 is not necessarily implemented by the computer system, and may be implemented by an analog circuit.

Plural functions of backup power supply system 1 are not essentially integrated into one housing. Components of backup power supply system 1 may be distributed in plural housings. At least some functions of backup power supply system 1, i.e., some functions of controller 14, may be realized by cloud (cloud computing). Furthermore, in the case that backup power supply system 1 is installed to a vehicle, some functions of controller 14 may be realized by an ECU of the vehicle.

In the above exemplary embodiment, power storage unit 13 is not necessarily the EDLC, and may be a secondary battery, such as a lithium ion capacitor (LIC) or a lithium ion battery (LIB). A positive electrode of the LIC is made of material similar to that of the EDLC (e.g., active carbon), and a negative electrode is made of material similar to that of the LIB (e.g., carbon material such as graphite).

Power storage unit 13 may be an electric chemical device having a structure described below. The electric chemical device includes a positive electrode member, a negative electrode member, and nonaqueous electrolyte. The positive electrode member includes a positive electrode collector and a positive electrode material layer that is carried on the positive electrode collector and includes a positive electrode active material. The positive electrode material layer includes conductive polymer as the positive electrode active material that dopes or dedopes anion (dopant). The negative electrode member includes a negative electrode material layer including a negative electrode active material. The negative electrode active material is, for example, a substance that proceeds oxidation-reduction reaction accompanying occlusion and release of lithium ions. More specifically, the negative electrode active material is a carbon material, a metal compound, alloy, a ceramic material, or the like. The nonaqueous electrolyte has, for example, lithium-ion conductivity. This type of nonaqueous electrolyte includes lithium salt and a nonaqueous solution that dissolves lithium salt. The electric chemical device as configured above has high energy density compared with the EDLC.

In accordance with the above embodiment, load 3 connected to output port T2 is not limited to one, and plural loads 3 may be connected to output port T2. In the case that lower limit threshold voltages of plural loads 3 are different from one another, the output voltage of second voltage converter 12 is preferably set to a voltage value higher than the highest lower limit threshold voltage among the lower limit threshold voltages of the loads.

In accordance with the above embodiment, the number of first capacitor C1, second capacitor C2, and third capacitor C3 is not limited to one. Each of first capacitor C1, second capacitor C2, and third capacitor C3 may include plural capacitors connected in series or parallel to one another.

In the above exemplary embodiment, “lower” in a comparison of two values, such as voltage values, may be “lower than or equal to”. More specifically, in the comparison of two values, whether to include a case where two values are equal can be arbitrary changed according to setting of reference values, and therefore there is no difference in a technical aspect between “lower” and “lower than or equal to”. Similarly, “higher than or equal to” in the description may be rephrased as “higher”.

### (3.1) Modification 1

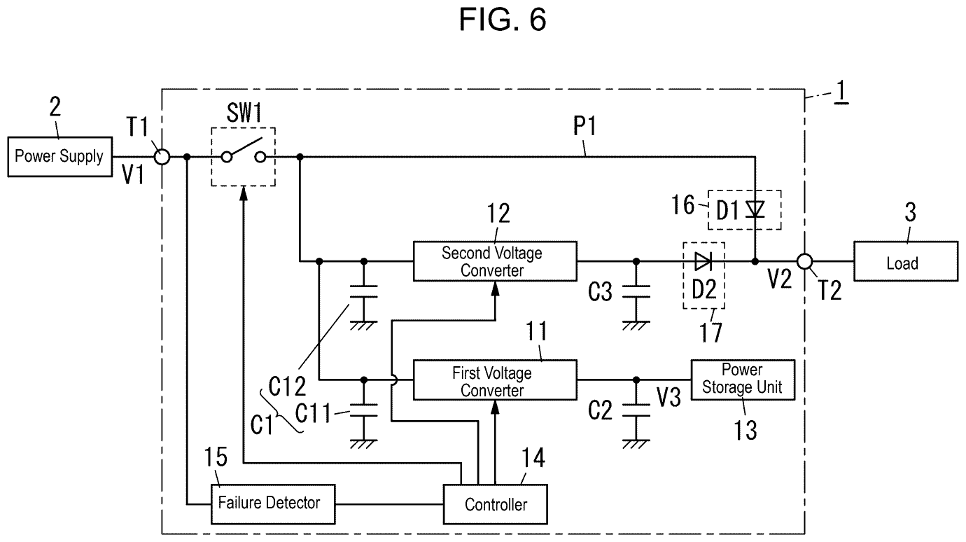

Modification 1 of backup power supply system 1 will be described with reference to FIG. 6.

Backup power supply system 1 according to Modification 1 is different from backup power supply system 1 according to the above embodiment in that Modification 1 includes two first capacitors C11 and C12 instead of first capacitor C1. Configuration other than first capacitors C11 and C12 is the same as that of backup power supply system 1 according to the above embodiment, and thus same reference marks are given to common components to omit their description.

First capacitor C11 has a first end and a second end. The first end of the first capacitor C11 is connected between input port T1 and first voltage converter 11. The second end of the first capacitor C11 is connected to ground.

First capacitor C12 has a first end and a second end. The first end of the first capacitor C12 is connected between input port T1 and second voltage converter 12. The second end of the first capacitor C12 is connected to ground.

Backup power supply system 1 according to Modification 1 further includes first capacitor C12 having the first end connected between first second voltage converter 12 and input port T1 in addition to first capacitor C11 having the first send connected between first voltage converter 11 and input port T1. Therefore, an element having a capacity needed for supplying power to load 3 in first period TP1 may be selected for first capacitor C12 connected to the input side of second voltage converter 12, thereby supplying power that load 3 needs in first period TP1.

Note that each of first capacitors C11 and C12 is not limited to one capacitor, and may include plural capacitors connected in series or parallel to one another.

### (3.2) Modification 2

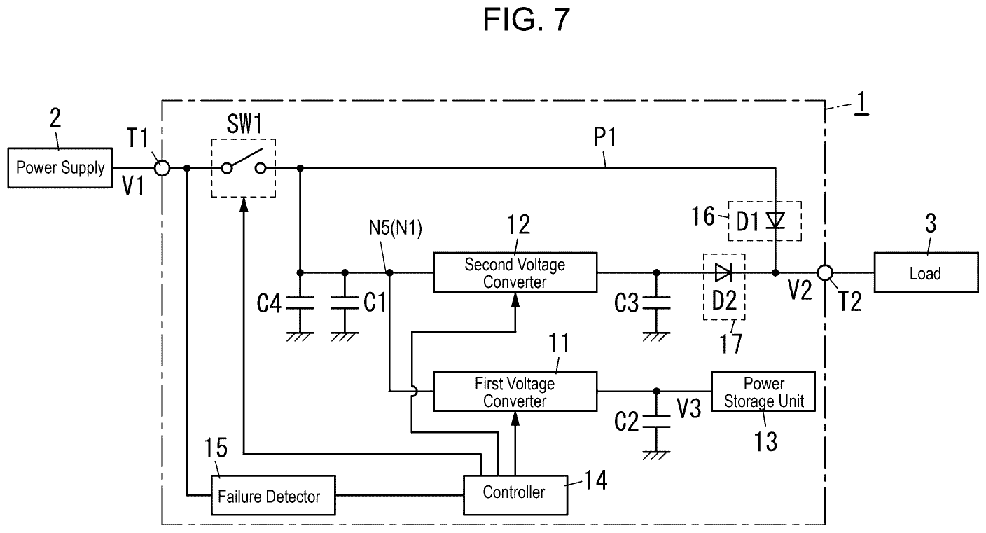

Modification 2 of backup power supply system 1 will be described with reference to FIG. 7.

Backup power supply system 1 according to Modification 2 is different from backup power supply system 1 according to the above embodiment in that Modification 2 further includes fourth capacitor C4 connected in parallel with first capacitor C1. Configuration other than fourth capacitor C4 is the same as backup power supply system 1 according to the above exemplary embodiment, and thus the same reference marks are given to common components to omit their description.

Fourth capacitor C4 has a first end and a second end. The first end of the fourth capacitor C4 is connected between input port T1 and node N5 (N1) connected to first voltage converter 11 and second voltage converter 12T1. The second end of the fourth capacitor C4 is connected to ground.

In the first power supply step, controller 14 controls second voltage converter 12 to boost a voltage of electrical energy stored in first capacitor C1 and fourth capacitor C4, and output boosted voltage of the stored electrical energy to output port T2.

Since second voltage converter 12 boosts the voltage of the electrical energy stored in first capacitor C1 and fourth capacitor C4 and outputs the boosted voltage of the stored electrical energy to load 3, thus supplying power that load 3 needs in first period TP1.

The number of fourth capacitors C4 is not limited to one, and may include plural capacitors connected in series or parallel to one another.

### (3.3) Modification 3

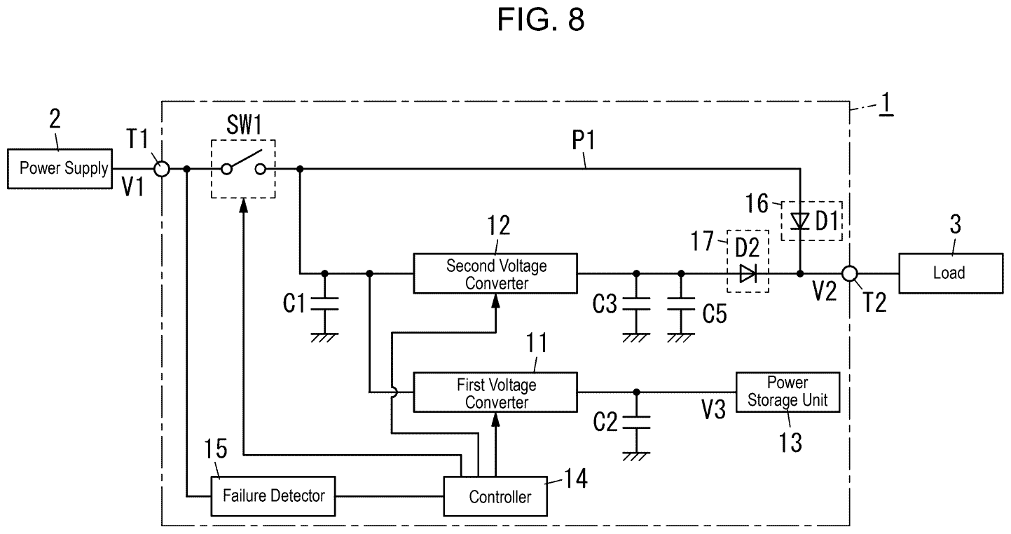

Modification 3 of backup power supply system 1 will be described with reference to FIG. 8.

Backup power supply system 1 according to Modification 3 is different from backup power supply system 1 according to the above embodiment in that Modification 3 further includes fifth capacitor C5 connected in parallel to third capacitor C3. Configuration other than fifth capacitor C5 is the same as backup power supply system 1 according to the above exemplary embodiment, and thus the same reference marks are given to common components to omit their description.

Fifth capacitor C5 has a first end and a second end. The first end of the fifth capacitor C5 is connected between second voltage converter 12 and output port T2. The second end of the fifth capacitor C5 is connected to ground.

In the first power supply step, backup power supply system 1 according to Modification 3 outputs electrical energy stored in third capacitor C3 and fifth capacitor C5 to output port T2.

As described above, the electrical energy stored in third capacitor C3 and fifth capacitor C5 is output to load 3, thereby stably supplying power that load 3 needs in first period TP1.

The number of fifth capacitors C5 is not limited to one, and may include plural capacitors connected in series or parallel to one another.

### (3.4) Modification 4

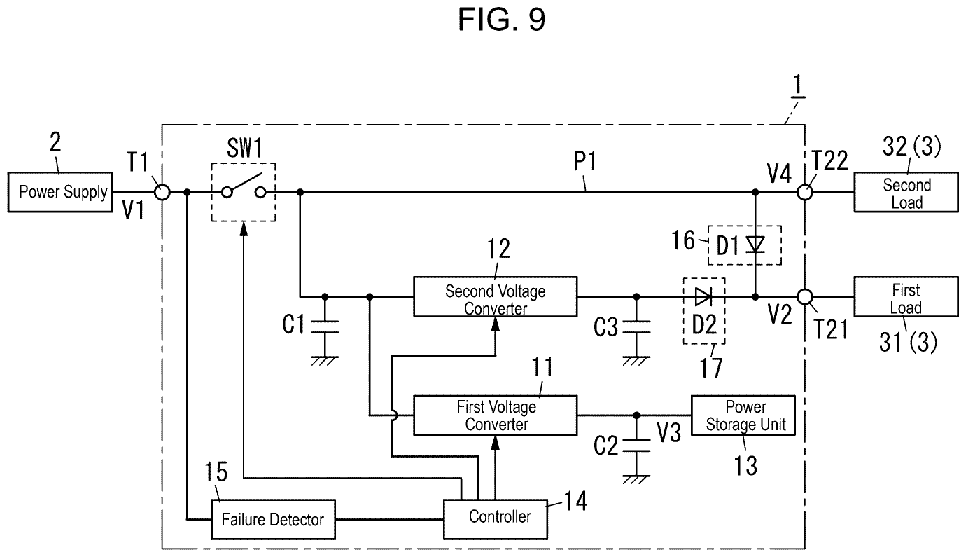

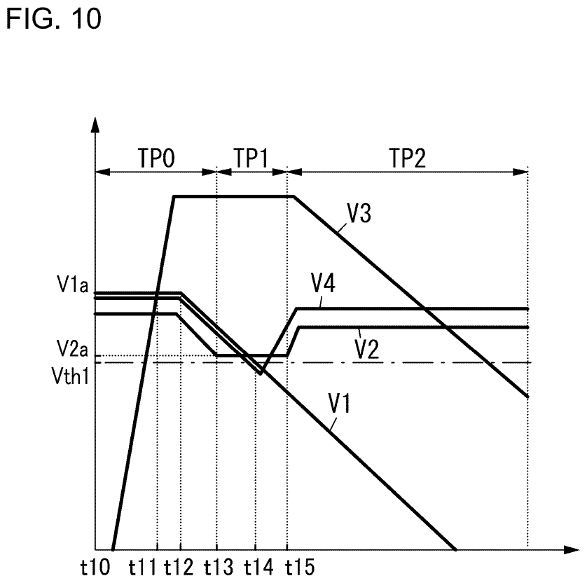

Modification 4 of backup power supply system 1 will be described with reference to FIGS. 9 and 10.

In backup power supply system 1 according to Modification 4, load 3 connected to backup power supply system 1 includes first load 31 and second load 32. First load 31 is configured to require continuous supply of a voltage higher than or equal to the lower limit threshold voltage. Second load 32 allows a state that the voltage supplied to second load 32 falls below the lower limit threshold voltage.

In backup power supply system 1 according to Modification 4, output port T2 in accordance with the above embodiment is first output port T21 connected to first load 31. Backup power supply system 1 further includes second output port T22 connected to second load 32. Second output port T22 is connected in power supply path P1 between input port T1 and reverse flow prevention unit (first reverse flow prevention unit) 16. More specifically, second output port T22 is connected in power supply path P1 between switch SW1 and first reverse flow prevention unit 16. Configuration other than first output port T21 and second output port T22 is the same as backup power supply system 1 according to the exemplary embodiment, and thus the same reference marks are given to common components to omit their description.

Since first reverse flow prevention unit 16 is connected between second output port T22 and second voltage converter 12, a voltage of power supply path P1 is supplied to second load 32 connected to second output port T22.

In the second power supply step, controller 14 controls first voltage converter 11 to convert a voltage of electrical energy discharged from power storage unit 13, and output the converted voltage of the discharged electrical energy to first output port T21 and second output port T22.

Backup power supply system 1 according to Modification 4 outputs input voltage V1 from power supply 2 to first load 31 and second load 32 in the non-failure state.

In the first power supply step, backup power supply system 1 outputs the voltage from second voltage converter 12 to first load 31 and outputs the voltage of power supply path P1 to second load 32.

In the second power supply step, backup power supply system 1 outputs the voltage from first voltage converter 11 to first load 31 and second load 32.

The operation of backup power supply system 1 according to Modification 4 will be described below with reference to FIG. 10.

FIG. 10 is a graph illustrating temporal changes of input voltage V1 from power supply 2, voltage V2 of first output port T21, voltage V3 of power storage unit 13, and voltage V4 of second output port T22 before and after the failure of power supply 2.

From time point t10 to time point t12 in FIG. 10, power supply 2 operates in the normal state, and input voltage V1 from power supply 2 has normal voltage value V1a. Input voltage V1 is higher than failure threshold Vth1 in a period from time point t10 to time point t12, and thus controller 14 causes first voltage converter 11 to operate in the charging step. In a period from time point t10 to time point t11, voltage V3 of power storage unit 13 is lower than input voltage V1 from power supply 2, and thus first voltage converter 11 steps down input voltage V1 and supplies a charging current to power storage unit 13 to charge power storage unit 13. After time point t11, voltage V3 of power storage unit 13 becomes higher than input voltage V1 from power supply 2, and thus first voltage converter 11 boosts input voltage V1 and supplies the charging current to power storage unit 13 to charge power storage unit 13. Power storage unit 13 is charged to have, for example, a voltage higher than normal voltage value V1a of power supply 2. In addition, controller 14 causes second voltage converter 12 to continuously perform the voltage conversion operation, and second voltage converter 12 converts the voltage across both ends of first capacitor C1 to predetermined second voltage value V2a and outputs the converted voltage from the second end. Second voltage value V2a of second voltage converter 12 is set to a voltage higher than the lower limit threshold voltage that can power load 3 and also higher than failure threshold Vth1, but lower than the voltage of power supply path P1 (here, voltage applied from power supply 2 to anode of diode D1) in the normal state. In the period from time point t10 to time point t12, the voltage of power supply path P1 is higher than voltage value V2a of output voltage V2 of second voltage converter 12, and thus the voltage of power supply path P1 is supplied to first load 31 via diode D1 and first output port T21 to operate first load 31. The voltage of power supply path P1 is supplied to second load 32 via second output port T22 to operate second load 32.

When any abnormality occurs in power supply 2 or a circuit between power supply 2 and input port T1 at time point t12, input voltage V1 from power supply 2 gradually decreases, but input voltage V1 in a period from time point t12 to time point t14 is still higher than failure threshold Vth1, and thus failure detector 15 outputs the detection signal of the non-failure state to controller 14. Therefore, even after the occurrence of abnormality, controller 14 performs the charging step of causing first voltage converter 11 to perform the charging operation in the period from time point t12 to time point t14.

In a period from time point t12 to time point t13, voltage V2 of first output port T21 gradually decreases according to decreasing input voltage V1. However, until time point t13, the voltage of power supply path P1 is higher than voltage value V2a of output voltage V2 of second voltage converter 12, and thus the voltage of power supply path P1 is supplied to first load 31 via diode D1 and first output port T21.

On the other hand, after time point t13, voltage value V2a of output voltage V2 of second voltage converter 12 becomes higher than the voltage of power supply path P1, and thus voltage value V2a of output voltage V2 of second voltage converter 12 is supplied to first load 31 via diode D2 and first output port T21. First reverse flow prevention unit 16 connected between input port T1 and first output port T21 reduces the possibility of a current flow from second voltage converter 12 to the side of power supply 2 via power supply path P1.

At time point t14, when input voltage V1 falls below failure threshold Vth1, controller 14 detects the occurrence of failure based on the detection signal from failure detector 15. Then, controller 14 turns off switch SW1 and causes first voltage converter 11 to stop the charging operation and perform the discharging operation. In other words, from time point t14, first voltage converter 11 starts the operation of stepping down or boosting the voltage of power storage unit 13 and outputting the stepped down or boosted voltage to power supply path P1. When first voltage converter 11 performs the discharging operation, a target value of the output voltage of first voltage converter 11 is set to a voltage higher than voltage value V2a of output voltage V2 of second voltage converter 11.

In the above operation, it takes a certain time until a rise of the output voltage of first voltage converter 11, and voltage value V2a of output voltage V2 of second voltage converter 12 is higher than the voltage of power supply path P1 (here, voltage applied from first voltage converter 11 to anode of diode D1) in a period from time point t14 to time point t15. Therefore, voltage value V2a of output voltage V2 of second voltage converter 12 is supplied to first load 31 via diode D2 and first output port T21. The output voltage of first voltage converter 11 is supplied to second load 32 via second output port T22. In this case, a period from time point t13 to time point t15 is before and after the failure of power supply 2, and is first period TP1 in which the voltage of power supply path P1 falls below the output voltage of second voltage converter 12. In first period TP1, controller 14 performs the first power supply step in which second voltage converter 12 is controlled to boost the voltage of electrical energy stored in first capacitor C1, and output the boosted voltage of the stored electrical energy to first output port T21. As a result, in first period TP1 before and after the failure of power supply 2 in which first voltage converter 11 cannot supply the voltage more than or equal to the lower limit threshold voltage to load 3, second voltage converter 12 converts the voltage of electrical energy stored in first capacitor C1 and supplies the voltage higher than or equal to the lower limit threshold voltage to first load 31. Accordingly, backup power supply system 1 continuously supplies the voltage higher than or equal to the lower limit threshold voltage to first load 31 that cannot allow the state that the voltage supplied to load 31 falls below the lower limit threshold voltage.

In a period from time point t14 to time point t15, the voltage supplied to second load 32 falls below the lower limit threshold voltage since the voltage of power supply path P1 is supplied to second load 32 via second output port T22. Also in this case, second load 32 operates with no problem since second load 32 is a load that allows the state that the voltage supplied to load 32 falls below the lower limit threshold voltage.

Then, in second period TP2 from time point t15, the output voltage of first voltage converter 11 rises, and thus the voltage of power supply path P1 becomes higher than voltage value V2a of output voltage V2 of second voltage converter 12. Accordingly, in second period TP2, controller 14 performs the second power supply step in which first voltage converter 11 is controlled to convert the voltage of electrical energy discharged from power storage unit 13, and output the converted voltage of the discharged electrical energy to first output port T21 and second output port T22 via power supply path P1.

As a result, in second period TP2 after the failure of power supply 2, first voltage converter 11 converts the voltage of electrical energy discharged from power storage unit 13 and supplies the converted volage of the discharged electrical energy to first load 31 and second load 32, thereby supplying the voltage higher than or equal to the lower limit threshold voltage to first load 31 and second load 32.

The lower limit threshold voltage of first load 31 and the lower limit threshold voltage of second load 32 may be different from each other. Voltage value V2a of output voltage V2 of second voltage converter 12 is preferably higher than the lower limit threshold voltage of first load 31 and lower than the voltage of power supply path P1 in the normal state.

First load 31 connected to first output port T21 is not limited to one, and plural first loads 31 may be connected to first output port T21. Second load 32 connected to second output port T22 is not limited to one, and plural second loads 32 may be connected to second output port T22.

### Conclusion

Aspects described below are disclosed according to the embodiment described above.

A method of controlling a backup power supply system (1) according to a first aspect is a method of controlling the backup power supply system (1) connected between a power supply (2) and a load (3). The backup power supply system (1) includes an input port (T1), an output port (T2), a power supply path (P1), a power storage unit (13), a first voltage converter (11), a second voltage converter (12), a reverse flow prevention unit (16), a controller (14), a first capacitor (C1), a second capacitor (C2), and a third capacitor (C3). The input port (T1) is connected to the power supply (2). The output port (T2) is connected to the load (3). The power supply path (P1) connects the input port (T1) to the output port (T2). The first voltage converter (11) is connected between the power supply path (P1) and the power storage unit (13). The second voltage converter (12) has a first end connected to the power supply path (P1) and a second end connected to the output port (T2). The reverse flow prevention unit (16) is connected between the input port (T1) and the output port (T2) and is configured to prevent a current flow from the second end of the second voltage converter (12) to the input port (T1). The controller (14) is configured to control the first voltage converter (11) and the second voltage converter (12). The first capacitor (C1) has a first end and a second end. The first end of the first capacitor (C1) is connected between the input port (T1) and each of the first voltage converter (11) and the second voltage converter (12). The second end of the first capacitor (C1) is connected to ground. The second capacitor (C2) has a first end and a second end. The first end of the second capacitor (C2) is connected between the first voltage converter (11) and the power storage unit (13). The second end of the second capacitor (C2) is connected to ground. The third capacitor (C3) has a first end and a second end. The first end of the third capacitor (C3) is connected between second voltage converter (12) and output port (T2). The second end of the third capacitor (C3) is connected to ground. When power supply (2) operates normally, the controller (14) performs a charging step in which the first voltage converter (11) is controlled to convert the input voltage from the power supply (2) and output the converted input voltage to the power storage unit (13). In the first period before and after the failure of the power supply (2) in which the output voltage of the first voltage converter (11) falls below the lower limit threshold voltage that can power the load (3), the controller (14) performs the first power supply step in which the second voltage converter (12) is controlled to boost the voltage of electrical energy stored in the first capacitor (C1), and output the boosted voltage of the stored electrical energy to the output port (T2). In the second period after the failure of power supply (2) in which the output voltage of the first voltage converter (11) becomes higher than or equal to the lower limit threshold voltage, the controller (14) performs the second power supply step in which the first voltage converter (11) is controlled to convert the voltage of electrical energy discharged from the power storage unit (13), and output the converted voltage of the discharged electrical energy to the output port (T2) via the power supply path (P1).

According to the first aspect, the voltage of the first capacitor (C1) does not exceed the input voltage from the power supply (2), and the second voltage converter (12) does not need to perform the step-down operation. The second voltage converter (12) only needs to perform the boosting operation of boosting the voltage of the first capacitor (C1) and outputting the boosted voltage to output port (T2). Accordingly, in the first aspect, a circuit configuration of second voltage converter (12) may be simplified as compared with the second voltage converter (12) that is implemented by a circuit capable of performing both the boosting operation and the stepping-down operation. This configuration reduces the size of the backup power supply system (1).

In a method of controlling the backup power supply system (1) according to a second aspect, the backup power supply system (1) according to the first aspect further includes a fourth capacitor (C4) connected in parallel to the first capacitor (C1). In the first power supply step, the controller (14) controls the second voltage converter (12) to boost the voltage of electrical energy stored in the first capacitor (C1) and the fourth capacitor (C4), and output the boosted voltage of the stored electrical energy to the output port (T2).

According to the second aspect, the second voltage converter (12) boosts the voltage of electrical energy stored in the first capacitor (C1) and the fourth capacitor (C4) and supplies the boosted voltage of the store electrical energy to load (3), thereby supplying power that load (3) needs in the first period.

In a method of controlling the backup power supply system (1) according to a third aspect, the backup power supply system (1) according to the first or second aspect further includes a fifth capacitor (C5) connected in parallel to the third capacitor (C3). In the first power supply step, electrical energy stored in the third capacitor (C3) and the fifth capacitor (C5) is output to the output port (T2).

According to the third aspect, electrical energy stored in the third capacitor (C3) and the fifth capacitor (C5) is output to the output port (T2) in the first power supply step, thereby stably supplying power to the load (3).

In a method of controlling the backup power supply system (1) according to a fourth aspect, the backup power supply system (1) according to one of first to third aspects further includes a switch (SW1) connected between the input port (T1) and the first capacitor (C1) and between the input port (T1) and the reverse flow prevention unit (16). When the power supply (2) fails, the controller (14) turns off the switch (SW1).

According to the fourth aspect, the possibility of a current flow from the backup power supply system (1) to a circuit on the side of the power supply (2) can be reduced when the power supply (2) fails.

In a method of controlling the backup power supply system (1) according to a fifth aspect, the load (3) according to one of first to fourth aspects includes a first load (31) and a second load (32). The first load (31) requires a continuous supply of the voltage higher than or equal to the lower limit threshold voltage. The second load (32) allows the state that the voltage supplied to the second load (32) falls below the lower limit threshold voltage. The output port (T2) is a first output port (T21) connected to the first load (31). The backup power supply system (1) further includes a second output port (T22) connected to the second load (32). The second output port (T22) is connected in power supply path (P1) between the input port (T1) and the reverse flow prevention unit (16). In the second power supply step, the controller (14) controls the first voltage converter (11) to convert the voltage of electrical energy discharged from power storage unit (13), and output the converted voltage of the discharged electrical energy to the first output port (T21) and the second output port (T22).

According to the fifth aspect, the voltage can be continuously supplied to the second load (32) connected to the second output port (T22).

In a method of controlling the backup power supply system (1) according to a sixth aspect, the reverse flow prevention unit (16) according to one of first to fifth aspects is a first reverse flow prevention unit. The backup power supply system (1) further includes a second reverse flow prevention unit (17) connected between the third capacitor (C3) and the output port (T2) and is configured to prevent a current flow in a direction from the output port (T2) toward the third capacitor (C3).

According to the sixth aspect, the possibility that the second voltage converter (12) operates to suppress the output in the non-failure state, due to the voltage of the power supply path (P1) applied to the second end of the second voltage converter (12), can be reduced.

A backup power supply system (1) according to a seventh aspect is a backup power supply system (1) configured to be connected between a power supply (2) and a load (3). The backup power supply system (1) includes an input port (T1), an output port (T2), a power supply path (P1), a power storage unit (13), a first voltage converter (11), a second voltage converter (12), a reverse flow prevention unit (16), a controller (14), a first capacitor (C1), a second capacitor (C2), and a third capacitor (C3). The input port (T1) is configured to be connected to the power supply (2). The output port (T2) is configured to be connected to the load (3). The power supply path (P1) connects the input port (T1) to the output port (T2). The first voltage converter (11) is connected between the power supply path (P1) and the power storage unit (13). The second voltage converter (12) has a first end and a second end. The first end of the second voltage converter (12) is connected to the power supply path (P1). The second end of the second voltage converter (12) is connected to the output port (T2). The reverse flow prevention unit (16) is connected between the input port (T1) and the output port (T2) and is configured to prevent a current flow from the second end of the second voltage converter (12) to the input port (T1). The controller (14) is configured to control the first voltage converter (11) and the second voltage converter (12). The first capacitor (C1) has a first end and a second end. The first end of the first capacitor (C1) is connected between the input port (T1) and each of the first voltage converter (11) and the second voltage converter (12). The second end of the first capacitor (C1) is connected to ground. The second capacitor (C2) has a first end and a second end. The first end of the second capacitor (C2) is connected between the first voltage converter (11) and the power storage unit (13). The second end of the second capacitor (C2) is connected to ground. The third capacitor (C3) has a first end and a second end. The first end of the third capacitor (C3) is connected between the second voltage converter (12) and the output port (T2). The second end of the third capacitor (C3) is connected to ground.

According to the seven aspect, the voltage of the first capacitor (C1) does not exceed the input voltage from the power supply (2). Therefore, the second voltage converter (12) does not need to perform the step-down operation, and may only perform the boosting operation on the voltage of the first capacitor (C1) to output to the output port (T2). Accordingly, in the seventh aspect, a circuit configuration of the second voltage converter (12) is simplified as compared with the second voltage converter (12) implemented by a circuit capable of performing both the boosting operation and the stepping-down operation. This configuration reduces the size of the backup power supply system (1).

The backup power supply system (1) according to an eighth aspect further includes a fourth capacitor (C4) connected in parallel to the first capacitor (C1) according to the seventh aspect.

According to the eighth aspect, the second voltage converter (12) boosts the voltage of electrical energy stored in the first capacitor (C1) and the fourth capacitor (C4) and supply the boosted voltage of the stored electrical energy to the load (3), thereby supplying power that load (3) needs in the first period.

The backup power supply system (1) according to a ninth aspect further includes a fifth capacitor (C5) connected in parallel to the third capacitor (C3) according to the seventh or eighth aspect.

According to the ninth aspect, electrical energy stored in the third capacitor (C3) and the fifth capacitor (C5) is output to the output port (T2) in the first power supply step, thereby stably supplying power to the load (3).

The backup power supply system according to a tenth aspect further includes a switch (SW1) according to one of the seventh to ninth aspects. The switch (SW1) is connected between the input port (T1) and the first capacitor (C1) and between the input port (T1) and the reverse flow prevention unit (16).

According to the tenth aspect, when the power supply (2) fails, the possibility of a current flow from the backup power supply system (1) to a circuit on the side of the power supply (2) can be reduced by turning off the switch (SW1).

In the backup power supply system (1) according to an eleventh aspect, the load (3) according to one of seventh to tenth aspects includes a first load (31) and a second load (32). The first load (31) requires a continuous supply of the voltage higher than or equal to the lower limit threshold voltage. The second load (32) allows the state that the voltage supplied to the second load (32) falls below the lower limit threshold voltage. The output port (T2) is a first output port (T21) configured to be connected to the first load (31). The backup power supply system (1) further includes a second output port (T22) configured to be connected to the second load (32). The second output port (T22) is connected in power supply path (P1) between the input port (T1) and the reverse flow prevention unit (16).

According to the eleventh aspect, a voltage is continuously supplied to the second load (32) connected to the second output port (T22).

In the backup power supply system (1) according to a twelfth aspect, the reverse flow prevention unit (16) according to one of seventh to eleventh aspects is a first reverse flow prevention unit. The backup power supply system (1) further includes a second reverse flow prevention unit (17) that is connected between the third capacitor (C3) and the output port (T2) and is configured to prevent a current flow in a direction from the output port (T2) toward the third capacitor (C3).

According to the twelfth aspect, the voltage of power supply path (P1) is applied to the second end of the second voltage converter (12) in the non-failure state, and reduces the possibility that the second voltage converter (12) operates to suppress the output.

Without being limited to the above aspects, various configurations (including modifications) of the backup power supply system (1) according to the embodiment can be embodied by the method of controlling the backup power supply system (1), a (computer) program, or a non-transitory storage medium storing the program, or the like.

The configurations according to the second to sixth aspects are not essential configurations for the method of controlling the backup power supply system (1), and may be omitted as appropriate. The configurations according to the eighth to twelfth aspects are not essential configurations for the backup power supply system (1), and may be omitted as appropriate.

### Reference Marks in the Drawings

1 backup power supply system
2 power supply
3 load
11 first voltage converter
12 second voltage converter
13 power storage unit
14 controller
16 reverse flow prevention unit (first reverse low prevention unit)
17 second reverse flow prevention unit
31 first load
32 second load
C1 first capacitor
C2 second capacitor
C3 third capacitor
C4 fourth capacitor
C5 fifth capacitor
P1 power supply path
SW1 switch
T1 input port
T2 output port
T21 first output port
T22 second output port

1. A method of controlling a backup power supply system connected between a power supply and a load, the method comprising:
preparing a backup power supply system including
an input port connected to the power supply,
an output port connected to the load,
a power supply path connecting the input port to the output port,
a power storage unit,
a first voltage converter connected between the power supply path and the power storage unit,
a second voltage converter having a first end and a second end, the first end of the second voltage converter being connected to the power supply path, the second end of the second voltage converter being connected to the output port,
a first reverse flow prevention unit connected between the input port and the output port, the first reverse flow prevention unit being configured to prevent a current flow from the second end of the second voltage converter to the input port,
a first capacitor having a first end and a second end, the first end of the first capacitor being connected between the first voltage converter and the second voltage converter and the input port, the second end of the first capacitor being connected to ground,
a second capacitor having a first end and a second end, the first end of the second capacitor being connected between the first voltage converter and the power storage unit, the second end of the second capacitor being connected to ground, and
a third capacitor having a first end and a second end, the first end of the third capacitor being connected between the second voltage converter and the output port, the second end of the third capacitor being connected to ground;
performing a charging step in which the first voltage converter is controlled to convert an input voltage from the power supply and output the converted input voltage to the power storage unit when the power supply operates normally;
performing a first power supply step in which the second voltage converter is controlled to boost a voltage of electrical energy stored in the first capacitor and output the boosted voltage of the stored electrical energy to the output port for a first period in which a voltage of the power supply path is lower than an output voltage of the second voltage converter before and after a failure of the power supply; and
performing a second power supply step in which the first voltage converter is controlled to convert a voltage of electrical energy discharged from the power supply unit and output the converted voltage of the discharged electrical energy to the output port via the power supply path for a second period in which the voltage of the power supply path is higher than or equal to the output voltage of the second voltage converter after the failure of the power supply.

2. The method according to claim 1, wherein
the backup power supply system further includes a fourth capacitor connected in parallel to the first capacitor, and
said performing the first power supply step comprises controlling the second voltage converter to boost a voltage of electrical energy stored in the first capacitor and the fourth capacitor and output the boosted voltage of the stored electrical energy to the output port.

3. The method according to claim 1, wherein
the backup power supply system further includes a fifth capacitor connected in parallel to the third capacitor, and
said performing the first power supply step comprises outputting electrical energy stored in the third capacitor and the fifth capacitor to the output port.

4. The method according to claim 1, wherein
the backup power supply system further includes a switch connected between the input port and the first capacitor and between the input port and the first reverse flow prevention unit, and
the method further comprises turning off the switch when the power supply fails.

5. The control method of the backup power supply system according to claim 1, wherein
the load includes a first load and a second load, the first load requiring a continuous supply of a voltage higher than or equal to a lower limit threshold voltage, the second load allowing a voltage supplied to the second load to be lower than the lower limit threshold voltage,
the output port is a first output port connected to the first load,
the backup power supply system further includes a second output port connected to the second load,
the second output port is connected in the power supply path and between the input port and the first reverse flow prevention unit, and
said performing the second power supply step comprises controlling the first voltage converter to convert the voltage of electrical energy discharged from the power storage unit and output the converted voltage of the discharged electrical energy to the first output port and the second output port.

6. The method according to claim 1, wherein the backup power supply system further includes a second reverse flow prevention unit connected between the third capacitor and the output port, the second reverse flow prevention unit being configured to prevent a current flow in a direction from the output port toward the third capacitor.

7. A backup power supply system configured to be connected between a power supply and a load, the backup power supply system comprising:
an input port configured to be connected to the power supply;
a first output port configured to be connected to the load;
a power supply path connecting the input port to the first output port;
a power storage unit;
a first voltage converter connected between the power supply path and the power storage unit;
a second voltage converter having a first end and a second end, the first end of the second voltage converter being connected to the power supply path, the second end of the second voltage converter being connected to the first output port;
a reverse flow prevention unit connected between the input port and the first output port, the reverse flow prevention unit being configured to prevent a current flow from the second of the second voltage converter to the input port;
a controller configured to control the first voltage converter and the second voltage converter;
a first capacitor having a first end and a second end, the first end of the first capacitor being connected between the first voltage converter and the second voltage converter, the second end of the first capacitor being connected to ground;
a second capacitor having a first end and a second end, the first end of the second capacitor being connected between the first voltage converter and the power storage unit, the second end of the second capacitor being connected to ground; and
a third capacitor having a first end and a second end, the first end of the third capacitor being connected between the second voltage converter and the first output port, the second end of the third capacitor being connected to ground.

8. The backup power supply system according to claim 7, further comprising a fourth capacitor connected in parallel to the first capacitor.

9. The backup power supply system according to claim 7, further comprising a fifth capacitor connected in parallel to the third capacitor.

10. The backup power supply system according to claim 7, further comprising a switch connected between the input port and the first capacitor and between the input port and the reverse flow prevention unit.

11. The backup power supply system according to claim 7, wherein the load includes a first load and a second load, the first load being configured to require a continuous supply of a voltage more than or equal to a lower limit threshold voltage, the second load allowing a voltage supplied to the second load to be lower than the lower limit threshold voltage,
the first output port is configured to be connected to the first load,
the backup power supply system further comprises a second output port configured to be connected to the second load, and
the second output port is connected in the power supply path between the input port and the reverse flow prevention unit.

12. The backup power supply system according to claim 7, wherein
the reverse flow prevention unit is a first reverse flow prevention unit, and
the backup power supply system further includes a second reverse flow prevention unit connected between the third capacitor and the first output port, the second reverse flow prevention unit being configured to prevent a current flow in a direction from the first output port toward the third capacitor.
